(19) United States
(12) Patent Application Publication
(10) Pub. No.: US 2026/0006634 A1
(43) Pub. Date: Jan. 1, 2026

(54) DATA POLLING FOR ENHANCED COMMUNICATIONS BETWEEN ELECTRONIC DEVICES

(71) Applicant: Apple Inc., Cupertino, CA (US)

(72) Inventors: Arun Vijayakumari MAHASENAN, Fremont, CA (US); Venkateswara Rao MANEPALLI, San Jose, CA (US)

(21) Appl. No.: 19/230,015

(22) Filed: Jun. 5, 2025

Related U.S. Application Data
(60) Provisional application No. 63/666,615, filed on Jul. 1, 2024.

(51) Int. Cl. H04W 74/06; H04L 5/00; H04W 24/08

(52) U.S. Cl. CPC H04W 74/06; H04L 5/0053; H04W 24/08

(57) ABSTRACT

The subject technology provides for data polling for electronic devices. An apparatus may initiate, based on a wakeup event, a data poll message that includes timing information indicating a time window during which the apparatus expects a data transmission associated with a first wireless communication protocol. The apparatus may provide for transmission, to a parent device, the data poll message. The apparatus may receive, from the parent device, an acknowledgement message indicating whether data is available for transmission to the apparatus. The apparatus may monitor for a data transmission associated with the first wireless communication protocol during at least a portion of the time window based on the acknowledgment message indicating that data is available for transmission to the apparatus. By indicating the time that an end device is available for data reception, the reliability of transmissions in a mesh network is increased.

### CROSS-REFERENCE TO RELATED APPLICATION(S)

This application claims the benefit of U.S. Provisional Application Ser. No. 63/666,615, entitled “DATA POLLING FOR ENHANCED COMMUNICATIONS BETWEEN ELECTRONIC DEVICES,” and filed on Jul. 1, 2024, the disclosure of which is expressly incorporated by reference herein in its entirety.

### TECHNICAL FIELD

The present description generally relates to wireless communication systems and, in particular to, data polling for enhanced communications between electronic devices.

### BACKGROUND

A mesh network may include router devices to forward packets between end devices of the network. That is, the end devices communicate with a corresponding router of the network but may not forward packets for other network devices. In this way, the router may act as a parent device for the end devices. End devices wake and poll their parent device. However, packet reception by end devices with a shared radio presents challenges relating to coexistence between the shared radios.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 conceptually illustrates an example of a system for performing signaling between an end device and a router in a mesh network in accordance with one or more implementations.

FIG. 3 is a schematic diagram illustrating an example enhanced data poll procedure between a parent device and a child device in accordance with one or more implementations.

FIG. 4 is a flow chart of an example process that may be performed by processing circuitry of a child device for enhanced data poll in accordance with one or more implementations.

FIG. 5 is a flow chart of an example process that may be performed by processing circuitry of a parent device for enhanced data poll in accordance with one or more implementations.

FIG. 6A conceptually illustrates an example of a resource grid with an example data poll procedure in accordance with one or more implementations.

FIG. 6B conceptually illustrates another example of a resource grid with an example enhanced data poll procedure in accordance with one or more implementations.

FIG. 7 conceptually illustrates another example of a resource grid with another example enhanced data poll procedure in accordance with one or more implementations.

FIG. 8 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The present disclosure relates to enabling communication between end devices of a network. In some cases, communication may be enabled via a temporary connection (e.g., on demand and/or on an as-needed basis). Specifically, the network may include a mesh network and the communication between devices may be in accordance with the mesh network communication protocol. For example, the mesh network communication protocol may utilize a router to forward packets between end devices of the mesh network. That is, the router may act as a parent device for the end devices. The parent device may provide connectivity and manage communication with the end devices. As such, an end device may utilize a radio to transmit a message to another end device, e.g., over the mesh network, via the router. In other examples, end devices may communicate with each other over the mesh network without a router. In one example, the router may forward information between the mesh network and a non-mesh network, such as a Wi-Fi network. In that case, the router may be referred to as a “border router” and convert a Wi-Fi message to the mesh network communication protocol and transmit the converted mesh network message to the target end device using a mesh network radio.

In one or more implementations, the end devices may be sleepy end devices (SEDs), which are normally disabled (e.g., asleep) and wake on occasion to poll for messages from a parent device (e.g., the router). In this regard, SEDs can include battery-powered accessories that exhibit intermittent radio functionality due to resource or battery constraints. In one or more implementations, an SED may awaken when a “wakeup message” is received. For example, the router may transmit the wakeup message to the SED. The wakeup message may instruct the SED to wake-up to poll for messages at a time different than a schedule polling period. In one or more implementations, the end devices may continue to operate as SEDs and use coordinated sampled listening (CSL) techniques to communicate (e.g., via the mesh network communication protocol).

When an electronic device, such as a phone, integrates into a mesh network, the electronic device may function as a SED because of its multiple radios, including Bluetooth, Wi-Fi, and mesh network radios, operating in a designated frequency spectrum (e.g., 2.4 gigahertz (GHz) band or the like). Concurrent operation of these radios introduces challenges due to coexistence constraints. The IEEE 802.15.4 standard addresses these challenges by introducing SEDs and defining data port procedures for receiving incoming data. During data polling, the SED periodically enters sleep state to conserve power and awakens to query its leader (or parent device) for data. If data is available, the parent device buffers the data until the SED retrieves it, necessitating the SED to activate its receiver for a specified duration. However, continuous reception for a specified duration (e.g., 100 milliseconds) presents challenges related to power consumption in coexistence-constrained devices such as SEDs.

Embodiments of the subject technology provide for enhanced data polling. In one or more implementations, the enhanced data polling schedules reception in intermediate slots when Bluetooth and Wi-Fi are inactive, improving coexistence and reducing the power consumption of end devices compared to continuous waiting periods. Enhanced data polling facilitates the optimization of efficient data retrieval while minimizing power consumption within a mesh network, improving overall system performance.

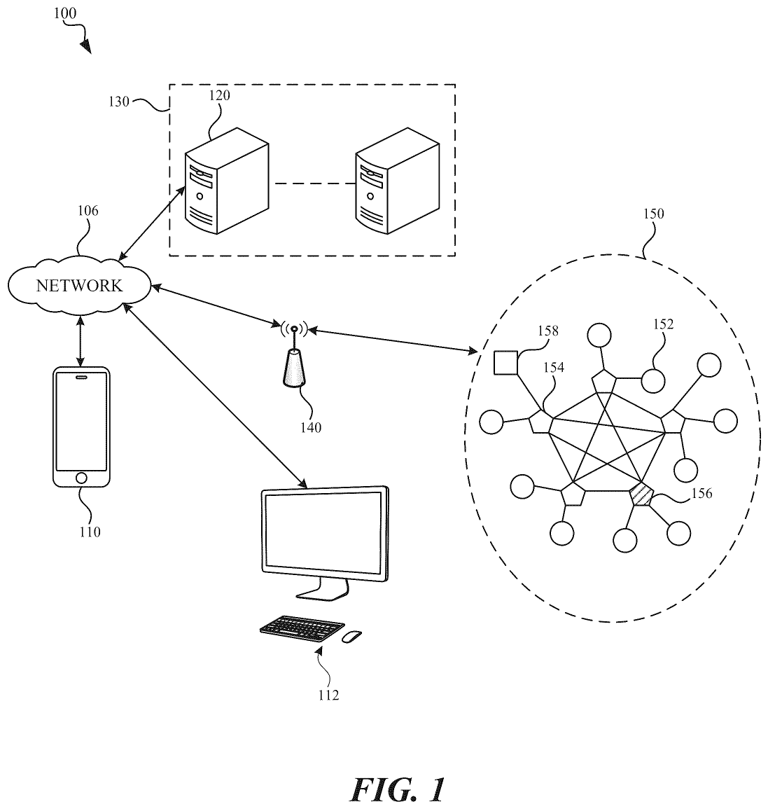

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the scope of the claims as set forth herein. Additional components, different components, or fewer components may be provided.

The following description is provided for the network environment 100 that operates in conjunction with the IEEE 802.15.4 standards for low-rate wireless personal area networks (LR-WPANs). It should be understood that the concepts disclosed herein may also be applied to other networks, including Thread®, Zigbee®, Z-Wave®, Bluetooth Low Energy (BLE), ISA100.11a, WirelessHART®, MiWi™, IPv6 over Low-Power Wireless Personal Area Networks (6LoWPAN), Subnetwork Access Protocol (SNAP), Wi-Fi mesh networks, and the like.

The network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

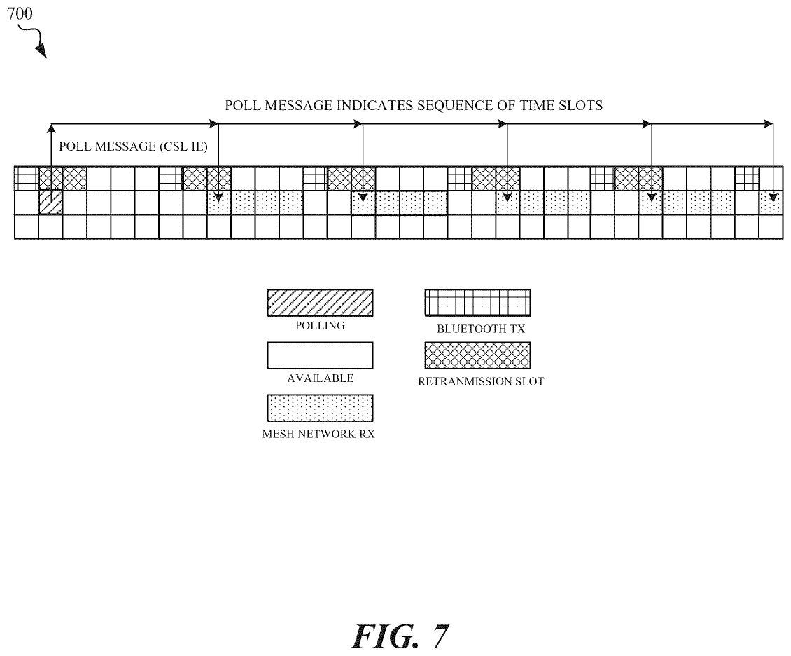

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

The electronic device 112 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 7.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

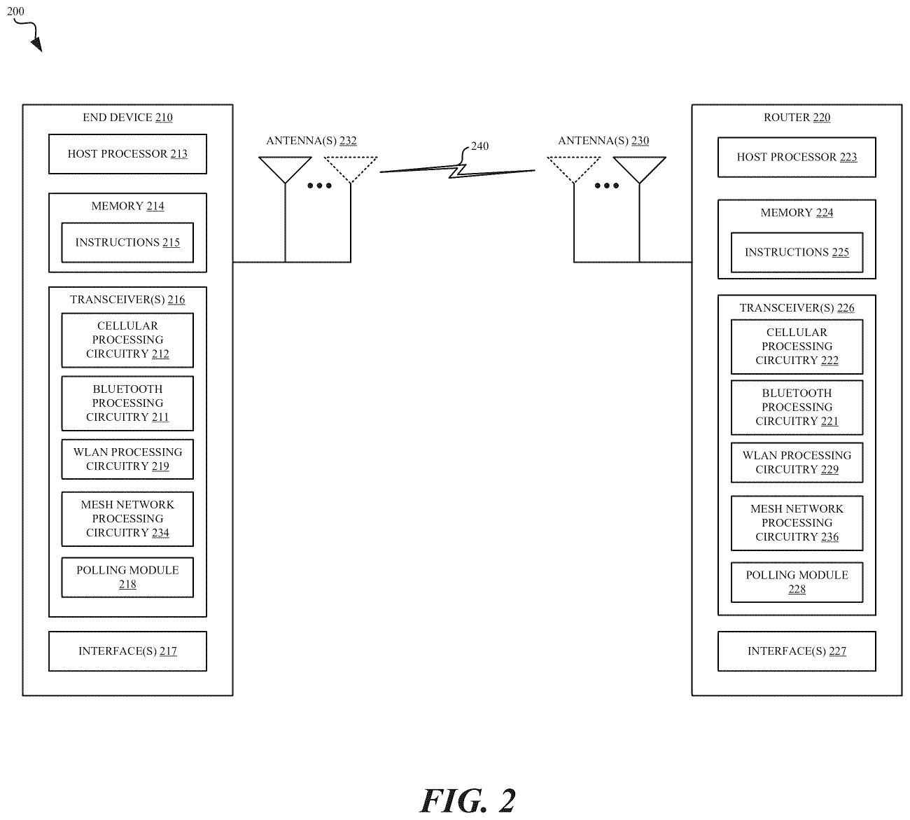

The mesh network 150 includes various end devices 152 and routers 154 (each of which may include any one of the electronic devices 110-112 of FIG. 1). In one or more implementations, the routers 154 (represented as pentagons) may forward packets (e.g., data) between and/or to the end devices 152 (represented as circles) of the mesh network 150. A router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive and transmit packets.

If a router 154 does not have any child devices (e.g., communicatively coupled end devices 152), the router 154 may be downgraded and/or configured to operate as an end device 152. Conversely, if a new end device attempting to join the mesh network 150 is within range of a current end device 152 of the mesh network 150 (but not a router 154), and that end device 152 is eligible to become a router 154, the end device 152 may be upgraded and/or configured to operate as a router 154 for the new end device. In that case, the new router 154 acts as a router 154 with respect to the new end device and is coupled to one or more other routers 154 of the mesh network 150.

Each end device 152 of the mesh network 150 may communicate primarily with a single router 154. For example, the end devices 152 may not forward packets for other network devices (e.g., end devices 152 and router 154). In one or more implementations, the end devices 152 are SEDs and may disable their respective transceivers (e.g., in the form of the transceiver 216 of FIG. 2) to reduce power consumption. In such cases, the end devices 152 serving as SEDs may wake on occasion to poll for messages from a corresponding router 154. An interval between polling for an end device 152 may be based on a schedule or other configuration of a corresponding transceiver (e.g., the transceiver 216 of FIG. 2), and may be controlled by a processor, such as the host processor 213 of FIG. 2, the mesh network processing circuitry 234 of FIG. 2, and/or a power management unit (PMU) of the end device 152.

Examples of end devices 152 and/or routers 154 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some of the end devices 152 and/or routers 154 may be referred to as Internet-of-Things (IoT) devices.

The mesh network 150 also includes a router 156 that serves as a leader node in the mesh network 150. In one or more implementations, the router 156 as the leader node can manage the overall network structure and operation of the mesh network 150, including initialization, synchronization, and topological control. The router 156 may act as a parent device for an end device 152 serving as a SED, buffering incoming data while the SED is in a sleep state. This procedure involves a downlink message to the SED, where the router 156 buffers the data until the SED awakens and queries for the data, known as the polling procedure. The SED then keeps its receiver (e.g., receiver portion of the transceiver 216 of FIG. 2) active for a specified duration to receive the incoming data. In one or more other implementations, the mesh network 150 also includes a border router 158 that may forward information between the mesh network 150 and a non-mesh network, such as the network 106, through the access point 140. The border router 158 can convert a Wi-Fi message to the mesh network communication protocol and transmit the converted mesh network message to a target end device (e.g., end device 152) using a mesh network radio.

Challenges arise when integrating with electronic devices such as smartphones, where radio resources are shared among various wireless technologies such as Wi-Fi and Bluetooth, posing coexistence constraints. Continuous reception for a specified duration, such as 100 milliseconds, presents significant challenges in such coexistence-constrained devices, leading to interference with Bluetooth and Wi-Fi activities. The subject technology addresses this challenge with enhanced data polling, which optimizes data reception by scheduling the transmission of data in intermediate slots when other shared radio activities are inactive, improving coexistence and reducing the receive current of the end device 152. This approach enhances mesh network communication technologies, offering improved performance and efficiency in coexistence-constrained environments.

FIG. 2 conceptually illustrates an example of a system 200 for performing signaling between an end device and a router in a mesh network in accordance with one or more implementations. The system 200 may be a portion of the network environment 100. The end device 210 may be, for example, one of the electronic devices 110 of the network environment 100. The router 220 may be, for example, one of the electronic devices 110 of the network environment 100.

The end device 210 may include a host processor 213. The host processor 213 may execute instructions such that various operations of the end device 210 are performed. For example, the host processor 213 can serve as the CPU responsible for executing instructions and managing various tasks. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The end device 210 may include one or more transceiver(s) 216 that may include radio frequency (RF) transmitter and/or receiver circuitry that use the antenna(s) 232 of the end device 210 to facilitate signaling (e.g., the signaling 240) to and/or from the end device 210 with other devices (e.g., the router 220) according to corresponding wireless communication protocols (e.g., cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the end device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The end device 210 may include a memory 214. The memory 214 may be a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The end device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the radio frequency (RF) components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the end device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

In one or more implementations, the one or more transceivers 216 can operate in conjunction with the cellular processing circuitry 212 to facilitate cellular communication. The one or more transceivers 216 is responsible for converting digital data from the cellular processing circuitry 212 into radio signals for transmission over the air and for receiving incoming radio signals, which are then converted back into digital data for processing by the cellular processing circuitry 212. This collaboration enables the end device 210 to transmit and receive data, supporting functions such as voice calls, text messaging, internet access, and other wireless services. The cellular processing circuitry 212 manages the digital signal processing tasks, while the one or more transceivers 216 handle the analog RF operations, working together to enable wireless communication capabilities in the end device 210.

The end device 210 may include Bluetooth processing circuitry 211. The Bluetooth processing circuitry 211 is responsible for managing the transmission and reception of wireless signals to and from mobile devices (e.g., end device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the end device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the Bluetooth processing circuitry 211 to facilitate Bluetooth communication. The one or more transceivers 216 is responsible for converting digital data from the Bluetooth processing circuitry 211 into radio signals for transmission over the air and for receiving incoming radio signals, which are then converted back into digital data for processing by the Bluetooth processing circuitry 211. This collaboration enables the end device 210 to transmit and receive data, supporting functions such as audio services, Internet access, and other wireless services via Bluetooth. The Bluetooth processing circuitry 211 manages the digital signal processing tasks, while the one or more transceivers 216 handle the analog RF operations, working together to enable wireless communication capabilities in the end device 210.

The end device 210 may include WLAN processing circuitry 219. The WLAN processing circuitry 219 is responsible for managing the transmission and reception of wireless signals to and from mobile devices (e.g., end device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the end device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the WLAN processing circuitry 219 to facilitate Wi-Fi communication. The one or more transceivers 216 is responsible for converting digital data from the WLAN processing circuitry 219 into radio signals for transmission over the air and for receiving incoming radio signals, which are then converted back into digital data for processing by the WLAN processing circuitry 219. This collaboration enables the end device 210 to transmit and receive data, supporting functions such as voice calls, text messaging, Internet access, and other wireless services via Wi-Fi. The WLAN processing circuitry 219 manages the digital signal processing tasks, while the one or more transceivers 216 handle the analog RF operations, working together to enable wireless communication capabilities in the end device 210.

The end device 210 may include mesh network processing circuitry 234. The mesh network processing circuitry 234 is responsible for managing the transmission and reception of wireless signals to and from mobile devices (e.g., end device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the end device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 is responsible for converting digital data from the mesh network processing circuitry 234 into radio signals for transmission over the air and for receiving incoming radio signals, which are then converted back into digital data for processing by the mesh network processing circuitry 234. This collaboration enables the end device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the end device 210.

The end device 210 may include one or more antenna(s) 232 (e.g., one, two, four, or more). In implementations having multiple antenna(s) 230, the router 220 may perform multiple-in-multiple-out (MIMO), digital beamforming, analog beamforming, beam steering, etc. For implementations with multiple antenna(s) 232, the end device 210 may leverage the spatial diversity of such multiple antenna(s) 232 to send and/or receive multiple different data streams on the same time and frequency resources.

The end device 210 may include one or more interface(s) 217. The interface(s) 217 may be used to provide input to or output from the end device 210. For example, an end device 210 that is a UE may include interface(s) 217 such as microphones, speakers, a touchscreen, buttons, and the like to allow for input and/or output to the UE by a user of the UE. Other interfaces of such a UE may be made up of made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The end device 210 may include polling module 218. The polling module 218 may be implemented via hardware, software, or combinations thereof. For example, the polling module 218 may be implemented as a processor, circuit, and/or instructions 215 stored in the memory 214 and executed by the host processor 213 and/or the transceiver 216. In some examples, the polling module 218 may be integrated within the transceiver(s) 216. For example, the polling module 218 may be implemented by a combination of software components (e.g., executed by a DSP or a general processor) and hardware components (e.g., logic gates and circuitry) within the transceiver(s) 216. In other examples, the polling module 218 is a separate component from the transceiver(s) 216.

The polling module 218 may be used for various aspects of the present disclosure, for example, aspects of FIG. 1 through FIG. 6. The polling module 218 is configured to, for example, initiate, based at least in part on a wakeup event, a data poll message that includes timing information indicating an available time window during which the end device 210 expects a data transmission associated with a first wireless communication protocol. In one or more implementations, the timing information includes an offset value that indicates a first available time window opportunity and a period value that indicates a number of subsequent available windows of opportunity for transmission (e.g., reusing slots allocated as Bluetooth retransmission opportunities). In one or more other implementations, the data poll message may indicate a length of an incoming frame configured to fit inside the available time window, which may correspond to the size of a maximum packet length. In one or more other implementations, the data poll message indicates the number of retransmissions possible. In one or more other implementations, the data poll message indicates the timing information, the maximum packet length, and the number of retransmissions.

The polling module 218 is also configured to, for example, provide for transmission, to the router 220, the data poll message. The polling module 218 is also configured to, for example, receive, from the router 220, an acknowledgement message indicating whether data is available for transmission to the end device 210. The polling module 218 is also configured to, for example, monitor for a data transmission associated with the first wireless communication protocol during at least a portion of the time window based on the acknowledgment message indicating that data is available for transmission to the end device 210. The polling module 218 is also configured to, for example, receive, from the router 220, the data transmission associated with the first wireless communication protocol during the at least a portion of the time window. For example, the data transmission may be scheduled at a specific time within the time window by the router 220 in accordance with the timing information provided by the end device 210.

The router 220 may include a host processor 223. The host processor 223 may execute instructions such that various operations of the router 220 are performed. For example, the host processor 223 can serve as the central processing unit (CPU) responsible for executing instructions and managing various tasks. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The router 220 may include one or more transceiver(s) 226 that may include RF transmitter and/or receiver circuitry that use the antenna(s) 230 of the router 220 to facilitate signaling (e.g., the signaling 240) to and/or from the router 220 with other devices (e.g., the end device 210) according to corresponding wireless communication technologies and/or protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the router 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The router 220 may include a memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The router 220 may include cellular processing circuitry 222. The cellular processing circuitry 222 is responsible for managing the transmission and reception of wireless signals to and from mobile devices (e.g., end device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the router 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the cellular processing circuitry 222 to facilitate cellular communication. The one or more transceivers 226 is responsible for converting digital data from the cellular processing circuitry 222 into radio signals for transmission over the air and for receiving incoming radio signals, which are then converted back into digital data for processing by the cellular processing circuitry 222. This collaboration enables the router 220 to transmit and receive data, supporting functions such as voice calls, text messaging, Internet access, and other wireless services via cellular. The cellular processing circuitry 222 manages the digital signal processing tasks, while the one or more transceivers 226 handle the analog RF operations, working together to enable wireless communication capabilities in the router 220.

The router 220 may include Bluetooth processing circuitry 221. The Bluetooth processing circuitry 221 is responsible for managing the transmission and reception of wireless signals to and from mobile devices (e.g., end device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the router 220 are performed, as described herein. The Bluetooth processing circuitry 221 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the Bluetooth processing circuitry 221 to facilitate Bluetooth communication. The one or more transceivers 226 is responsible for converting digital data from the Bluetooth processing circuitry 221 into radio signals for transmission over the air and for receiving incoming radio signals, which are then converted back into digital data for processing by the Bluetooth processing circuitry 221. This collaboration enables the router 220 to transmit and receive data, supporting functions such as audio services, Internet access, and other wireless services via Bluetooth. The Bluetooth processing circuitry 221 manages the digital signal processing tasks, while the one or more transceivers 226 handle the analog RF operations, working together to enable wireless communication capabilities in the router 220.

The router 220 may include WLAN processing circuitry 229. The WLAN processing circuitry 229 is responsible for managing the transmission and reception of wireless signals to and from mobile devices (e.g., end device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the router 220 are performed, as described herein. The WLAN processing circuitry 229 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the WLAN processing circuitry 229 to facilitate Wi-Fi communication. The one or more transceivers 226 is responsible for converting digital data from the WLAN processing circuitry 229 into radio signals for transmission over the air and for receiving incoming radio signals, which are then converted back into digital data for processing by the WLAN processing circuitry 229. This collaboration enables the router 220 to transmit and receive data, supporting functions such as voice calls, text messaging, Internet access, and other wireless services via Wi-Fi. The WLAN processing circuitry 229 manages the digital signal processing tasks, while the one or more transceivers 226 handle the analog RF operations, working together to enable wireless communication capabilities in the router 220.

The router 220 may include mesh network processing circuitry 236. The mesh network processing circuitry 236 is responsible for managing the transmission and reception of wireless signals to and from mobile devices (e.g., end device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the router 220 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the router 220 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the router 220.

The router 220 may include one or more antenna(s) 230 (e.g., one, two, four, or more). In implementations having multiple antenna(s) 230, the router 220 may perform multiple-in-multiple-out (MIMO), digital beamforming, analog beamforming, beam steering, etc.

The router 220 may include one or more interface(s) 227. The interface(s) 227 may be used to provide input to or output from the router 220. For example, a router 220 may include interface(s) 227 made up of transmitters, receivers, and other circuitry (e.g., other than the transceiver(s) 226/antenna(s) 230 already described) that enables the router 220 to communicate with other equipment in the mesh network 150, and/or that enables the router 220 to communicate with external networks, computers, databases, and the like for purposes of operations, administration, and maintenance of the router 220 or other equipment operably connected thereto.

The router 220 may include a polling module 228. The polling module 228 may be implemented via hardware, software, or combinations thereof. For example, the polling module 228 may be implemented as a processor, circuit, and/or instructions 225 stored in the memory 224 and executed by one or more components in the transceiver 226. In some examples, the polling module 228 may be integrated within the transceiver(s) 226. For example, the polling module 228 may be implemented by a combination of software components (e.g., executed by a DSP or a general processor) and hardware components (e.g., logic gates and circuitry) within the transceiver(s) 226. In other examples, the polling module 228 is a separate component from the transceiver(s) 226.

The polling module 228 may be used for various aspects of the present disclosure, for example, aspects of FIG. 1 through FIG. 6. The polling module 228 is configured to, for example, receive, from the end device 210, a data poll message that includes timing information indicating an available time window during which the end device 210 expects a data transmission associated with a first wireless communication protocol following a wakeup event at the end device 210. In one or more other implementations, the data poll message may indicate a length of an incoming frame configured to fit inside the available time window, which may correspond to the size of a maximum packet length. In one or more other implementations, the data poll message indicates the number of retransmissions possible. The polling module 228 is also configured to, for example, provide for transmission, to the end device 210, an acknowledgement message indicating whether data is available for transmission to the end device 210. The polling module 228 is also configured to, for example, schedule a data transmission associated with the first wireless communication protocol based at least in part on the timing information. The polling module 228 is also configured to, for example, provide for transmission, to the end device 210, the data transmission associated with the first wireless communication protocol.

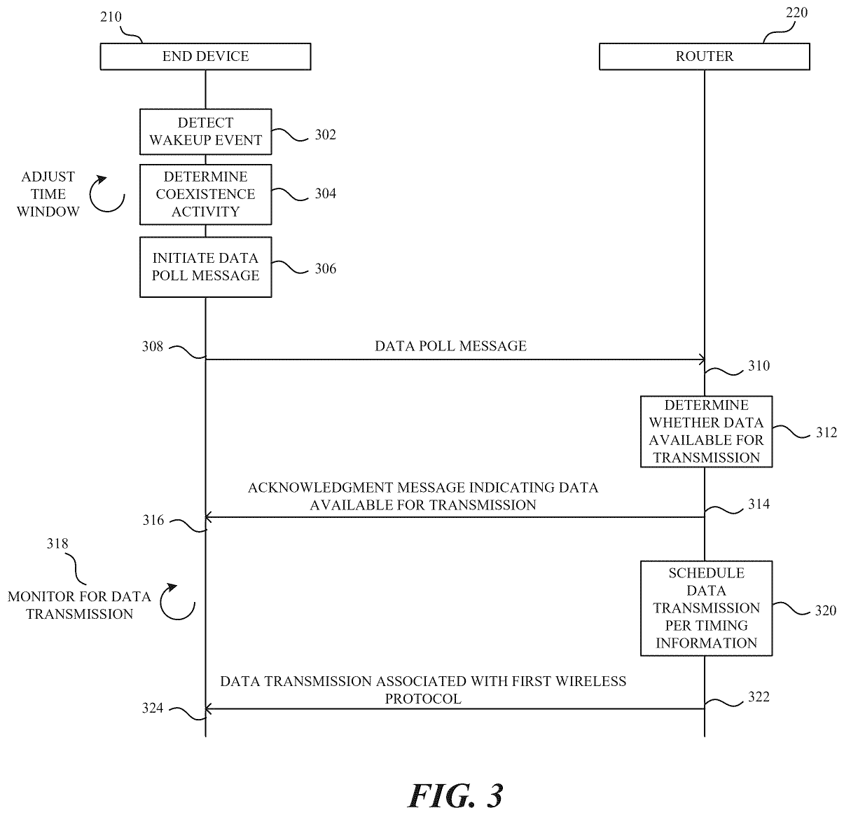

FIG. 3 is a schematic diagram illustrating an example enhanced data poll procedure between a router 220 (e.g., router 154 of FIG. 1 or router 156 of FIG. 1) and an end device 210 (e.g., end device 152 of FIG. 1) in accordance with one or more implementations. Embodiments of the subject technology provide for enhanced data polling that addresses challenges in mesh networks. In one or more implementations, a mesh network includes one or more SEDs that may refer to battery-powered devices and/or power-constrained devices. These types of devices may not have an always-on radio due to resource or battery constraints, which prevent continuous operation of the radio. In a mesh network, leader nodes and routers, which are main-powered devices, always remain active and listening on a communication medium. A leader node may function as a host device within a mesh network. Examples of leader nodes include devices such as smart light bulbs or security cameras, which are line-powered devices capable of acting as mesh network routers. When an electronic device such as a phone joins a mesh network, it can function as a SED because it may contain multiple radios associated with one or more wireless communication protocols, including Bluetooth, Wi-Fi, and a mesh network radio. However, all these radios may operate on the 2.4 GHz frequency, creating challenges for concurrent operation due to coexistence constraints within this frequency band.

The IEEE 802.15.4 standard may define data polling procedures between a SED serving as an end device 210 and a router serving as a router 220 to enable the end device 210 to receive incoming data from the router 220. The end device 210 can conserve power by periodically entering a sleep state. For example, if Bluetooth audio is streaming from the end device 210 to a wearable device such as an ear pod and the user attempts to unlock a door, the child device's mesh network radio may be turned off. Periodically, the end device 210 may wake up to check for incoming data. For example, the end device 210 may poll its router 220 to determine if there is any buffered data. The router 220 can respond to the child device's polling message by sending the data to the end device 210. For example, these leader nodes and/or routers, serving as parent devices for SEDs, buffer incoming data while the SEDs are in a sleep state. When a router 220 buffers data for an end device 210 (e.g., a SED), the data polling procedure involves the router 220 holding the data until the end device 210 wakes up and queries for it. If the router 220 indicates data is available, the end device 210 keeps its receiver on for a specified duration (e.g., about 200 milliseconds) while the router 220 sends the buffered data to the end device 210. If the router 220 indicates there is no data, the end device 210 immediately returns to the sleep state.

When an end device 210 has a dedicated radio, such as a standalone radio without coexistence challenges, the data polling procedure operates effectively. However, with the end device 210 implemented as a phone, there may be no dedicated radio because the radio is shared among Wi-Fi, Bluetooth, and other wireless communication protocols. As a result, the end device 210's radio may not continuously receive for a specified duration without interfering with Bluetooth activity, such as voice quality, or Wi-Fi traffic. Continuous reception for 100 milliseconds poses significant challenges in a coexistence-constrained device, such as the end device 210.

The enhanced data poll procedure as described with reference to FIG. 3 optimizes the polling process by scheduling reception during intermediate slots when other wireless communication protocols such as Bluetooth and Wi-Fi are not active, rather than requiring continuous reception by the end device 210 for at least a specified duration (e.g., about 100 milliseconds). This approach improves coexistence between a mesh network radio with Bluetooth and Wi-Fi and reduces the receive current of the end device 210. Instead of waiting 400 milliseconds for data, the end device 210 can wait only for the scheduled slot. This approach offers a more efficient data polling process for coexistence-constrained devices.

As illustrated in FIG. 3, at 302, the end device 210 detects a wakeup event. For example, the end device 210 may receive a wakeup message (not shown) from the router 220 that causes the end device 210 to transition from a sleep state to a wakeup state (or active state). In one or more other implementations, the end device 210 may detect the wakeup event by transitioning out from the sleep state irrespective of receiving any wakeup signaling from the router 220. For example, the end device 210 may undergo periodic wakeups to poll its leader (e.g., the router 220).

At 304, the end device 210 may determine a coexistence activity between a transmitter associated with the first wireless communication protocol and a transmitter associated with a second wireless communication protocol different from the first wireless communication protocol. For example, the first wireless communication protocol may include a mesh network communication protocol and the second wireless communication protocol may include cellular, Bluetooth or Wi-Fi. In one or more implementations, the end device 210 may determine a time window during which the end device 210 expects to receive a data transmission associated with a first wireless communication protocol (e.g., mesh network communication protocol) based on the coexistence activity.

In one or more implementations, the time window value can vary depending on certain conditions, particularly the amount of traffic present for other wireless communication protocols. In one or more implementations, the end device 210 determines the criteria for establishing the time window value to anticipate incoming frames. The end device 210 possesses the autonomy to make these decisions based on various factors, including the ongoing activities such as streaming music, video calls, or other device functionalities. Different activities have different duty cycles, resulting in numerous combinations that can influence the time window determination process. For example, activities such as using a wearable device (e.g., a watch) or using a tablet with an attached pencil affect the available resources and allocated bandwidth. The end device 210 can evaluate the current resource allocation and availability to determine when it is ready to receive incoming frames, thus indicating its readiness to the router 220.

In one or more implementations, the end device 210 may adjust the time window based on the coexistence activity. In one or more other implementations, in determining the coexistence activity, the end device 210 may determine one or more available time slots following conclusion of an operation by the transmitter associated with the second wireless communication protocol. In one or more implementations, the time window may include the one or more available time slots.

At 306, the end device 210 initiates a data poll message (or data polling message) that includes timing information indicating the time window. In one or more other implementations, the data poll message may indicate a length of an incoming frame configured to fit inside the available time window, which may correspond to the size of a maximum packet length. In one or more other implementations, the data poll message indicates the number of retransmissions possible. In one or more implementations, the generation of a data poll message, triggered by the end device 210, may occur in response to user-initiated actions rather than external wake-up signals. These actions, such as unlocking a door or activating a light, prompt the transmission of data poll messages.

In one or more implementations, if there is significant traffic for a particular wireless communication protocol (e.g., Bluetooth), the time window is provided in the data poll message. In one or more other implementations, if there is minimal traffic for a particular wireless communication protocol (e.g., Bluetooth), the time window may not be provided in the data poll message. The value of this window is determined by the end device 210 based on the prevailing conditions.

In one or more implementations, the data poll message includes a CSL information element (CSL IE). In one or more other implementations, the timing information is included in at least a portion of the CSL IE. In one or more implementations, the CSL IE includes a timestamp indicating a particular time. For example, the timestamp may specify the particular time in Greenwich Mean Time (GMT) or Coordinated Universal Time (UTC). In one or more other implementations, the CSL IE includes any time indication. The CSLI IE encodes data to indicate when the end device 210 will begin listening for incoming data. This encoding may include an offset from the present time and a duration during which the end device 210 will listen. For example, the end device 210 may specify that it will begin listening at about 7.5 milliseconds from a current time indicated in the timestamp. If the router 220 confirms incoming data during this interval, the router 220 schedules transmission, accordingly, providing downlink data to the end device 210 at the specified time.

In one or more implementations, the timing information can include an offset value and a period value, in which the time window may be defined by the offset value and the period value. In one or more implementations, the offset value indicates an occurrence of a first time slot of one or more consecutive time slots following conclusion of an operation by a transmitter associated with a second wireless communication protocol (e.g., Bluetooth) different from the first wireless communication protocol (e.g., mesh network). In one or more other implementations, the period value indicates the periodicity between each subsequent occurrence of the first time slot. The timing information can aid in determining alternative transmission opportunities if the router 220 is unable to send data at a specified time. The CSL protocol may rely on the offset value to designate the next available transmission slot, followed by the periodicity, typically in regular intervals such as 7.5 milliseconds in Bluetooth communication. Unused time slots can remain available until needed for transmission. The offset value along with the period value and the number of attempts allowed, can determine the transmission scheduling, including potential retransmissions if the router 220 fails to transmit data.

At 308, the end device 210 provides for transmission, to the router 220, the data poll message. Conversely, at 310, the router 220 receives, from the end device 210, the data poll message that includes the timing information indicating an available time window during which the end device 210 expects a data transmission associated with the first wireless communication protocol following the wakeup event (e.g., 302) at the end device 210. In one or more implementations, data poll message may be sent using type-length-value (TLV) encoding, where the type specifies the command's length, and the value contains the command itself.

At 312, the router 220 may determine whether data is available for transmission to the end device 210. For example, the router 220 may determine whether there is data cached in memory of the router 220 that is intended for the end device 210.

In one or more implementations, downlink transmission from the router 220 to the end device 210 can occur at any time, as determined by the router 220. If the end device 210 indicates a specific time for reception and the router 220 has no data to send at that time, it promptly informs the end device 210, allowing it to proceed without waiting. This communication is bidirectional, with acknowledgments sent to the end device 210 to confirm receipt of messages.

At 314, the router 220 provides for transmission, to the end device 210, an acknowledgement message indicating whether data is available for transmission to the end device 210. In one or more implementations, the acknowledgment message includes timing information indicating that both end points (e.g., end device 210, router 220) have agreed on a sequence of time windows that can used for initial transmission followed by multiple retransmissions. Conversely, at 316, the end device 210 receives, from the router 220, the acknowledgement message indicating whether data is available for transmission to the end device 210. In one or more implementations, the acknowledgment message indicates that data is available for transmission. For example, if data is available at the router 220, the acknowledgment message will indicate that data is ready for transmission to the end device 210 in response to the poll. In one or more other implementations, the acknowledgment message indicates that data is not available for transmission. In this regard, the acknowledgment message will indicate that no data is ready for transmission to the end device 210 in response to the poll.

At 318, the end device 210 may monitor for reception of a data transmission associated with the first wireless communication protocol (e.g., mesh network transmission) from the router 220 during at least a portion of the time window based on the acknowledgment message indicating that data is available for transmission to the end device 210. In one or more other implementations, the end device 210 may activate a receiver associated with the first wireless communication protocol (e.g., mesh network radio receiver) during at least one of the one or more available time slots in the time window. For example, the end device 210 may monitor the communication medium at or around a time that corresponds to the offset value indicated in the timing information. In another example, the end device 210 may monitor the communication medium at or around the occurrence of the first time slot following conclusion of an operation by a Bluetooth transmitter at the end device 210.

In one or more other implementations, the end device 210 may transition into a sleep state (or low power state) based on the acknowledgment message indicating that data is not available for transmission to the end device 210. In this regard, the end device 210 may be in the sleep state until another wakeup event is detected.

At 320, the router 220 schedules a data transmission associated with the first wireless communication protocol based at least in part on the timing information. For example, the router 220 may determine one or more time slots at which to transmit data to the end device 210 based on the offset value and period value included in the timing information. In some aspects, if the router 220 is unable to transmit the data at a time slot indicated by the timing information, the router 220 may schedule transmission of the data at one or more subsequent time slots according to the period value. In some examples, these subsequent time slots may correspond to retransmission time slots associated with the second wireless communication protocol (e.g., Bluetooth retransmission slots) during which the end device 210 is available to receive a data transmission associated with the first wireless communication protocol.

At 322, the router 220 provides for transmission, to the end device 210, the data transmission associated with the first wireless communication protocol. Conversely, at 324, the end device 210 receives, from the router 220, the data transmission associated with the first wireless communication protocol during at least a portion of the time window. In one or more implementations, the data transmission is configured to align with at least one of the one or more available time slots in the time window. For example, the data transmission may be received at the end device 210 during a first time slot corresponding to the offset value and one or more subsequent consecutive time slots.

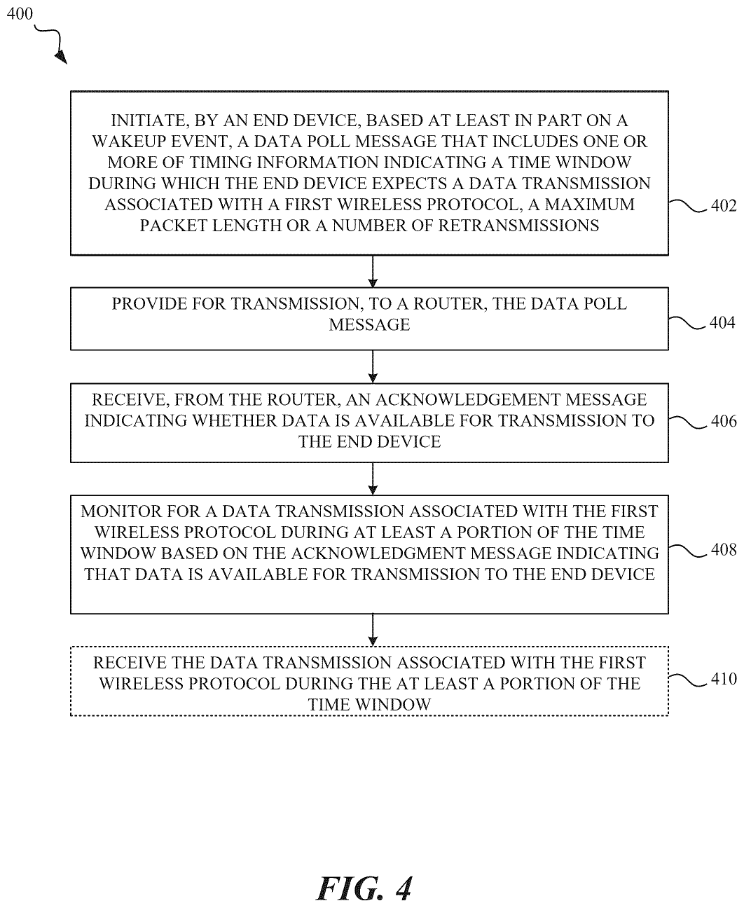

FIG. 4 is a flow chart of an example process 400 that may be performed by processing circuitry of a child device for enhanced data poll in accordance with one or more implementations. For explanatory purposes, the process 400 is primarily described herein with reference to an apparatus. However, the process 400 is not limited to the apparatus, and one or more blocks (or operations) of the process 400 may be performed by one or more other components of other suitable devices and/or servers. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In one or more implementations, the apparatus of FIG. 4 includes a mesh network processor (e.g., mesh network processing circuitry 234 of FIG. 2) coupled to a RF transceiver (e.g., one or more transceivers 216 of FIG. 2). The apparatus communicates using the mesh network processor through the RF transceiver with other end devices and/or routers. In one or more implementations, the apparatus is the entire end device (e.g., end device 210) and includes additional radios (e.g., cellular processing circuitry 212, Bluetooth processing circuitry 211, WLAN processing circuitry 219, mesh network processing circuitry 234).

As illustrated in FIG. 4, at block 402, the apparatus initiates a data poll message that includes timing information indicating an available time window during which the apparatus expects a data transmission associated with a first wireless communication protocol. In one or more other implementations, the data poll message may indicate a length of an incoming frame configured to fit inside the available time window, which may correspond to the size of a maximum packet length. In one or more other implementations, the data poll message indicates the number of retransmissions possible. In one or more implementations, the data poll message includes a CSL information element. In one or more other implementations, the timing information is included in at least a portion of the CSL information element. The timing information can include an offset value and a period value, in which the time window may be defined by the offset value and the period value. In one or more implementations, the offset value corresponds to a first available time slot following conclusion of an operation by a transmitter associated with a second wireless communication protocol different from the first wireless communication protocol.

In one or more other implementations, the apparatus may determine a coexistence activity between a transmitter associated with the first wireless communication protocol and a transmitter associated with a second wireless communication protocol different from the first wireless communication protocol. For example, the first wireless communication protocol may include a mesh network communication protocol and the second wireless communication protocol may include cellular, Bluetooth or Wi-Fi. In some aspects, the apparatus may adjust the time window based on the coexistence activity. In one or more other implementations, in determining the coexistence activity, the apparatus may determine one or more available time slots following conclusion of an operation by the transmitter associated with the second wireless communication protocol. In one or more implementations, the time window may include the one or more available time slots.

At block 404, the apparatus provides for transmission, to a parent device (e.g., router 154, router 156 of FIG. 1; router 220 of FIG. 2; parent device 320 of FIG. 3), the data poll message.

At block 406, the apparatus receives, from the parent device, an acknowledgement message indicating whether data is available for transmission to the apparatus. In one or more implementations, the acknowledgment message indicates that data is available for transmission to the apparatus. In one or more other implementations, the acknowledgment message indicates that data is not available for transmission to the apparatus.

At block 408, the apparatus monitors for a data transmission associated with the first wireless communication protocol during at least a portion of the time window based on the acknowledgment message indicating that data is available for transmission to the apparatus. In one or more other implementations, the apparatus may transition into a sleep state based on the acknowledgment message indicating that data is not available for transmission to the apparatus. In one or more other implementations, the apparatus may activate a receiver associated with the first wireless communication protocol during the at least one of the one or more available time slots in the time window.

At block 410, optionally, the apparatus receives, from the parent device, the data transmission associated with the first wireless communication protocol during the at least a portion of the time window. In one or more implementations, the data transmission is configured to align with at least one of the one or more available time slots in the time window.

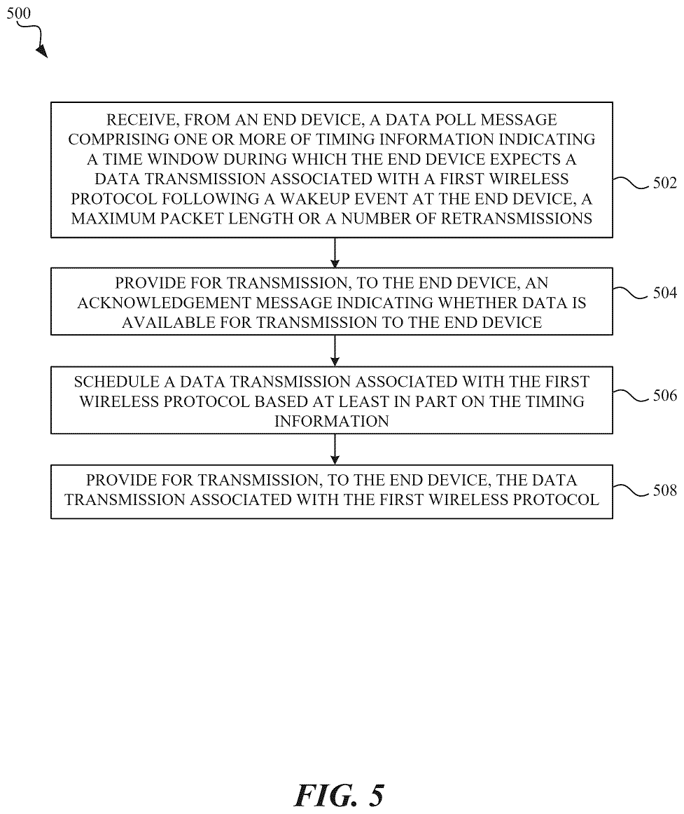

FIG. 5 is a flow chart of an example process 500 that may be performed by processing circuitry of a parent device for enhanced data poll in accordance with one or more implementations. For explanatory purposes, the process 500 is primarily described herein with reference to the an apparatus. However, the process 500 is not limited to the apparatus, and one or more blocks (or operations) of the process 500 may be performed by one or more other components of other suitable devices and/or servers. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In one or more implementations, the apparatus of FIG. 5 includes a mesh network processor (e.g., mesh network processing circuitry 236 of FIG. 2) coupled to a RF transceiver (e.g., one or more transceivers 226 of FIG. 2). The apparatus communicates using the mesh network processor through the RF transceiver with other end devices and/or routers. In one or more implementations, the apparatus is the entire router (e.g., router 220) and may include additional radios (e.g., cellular processing circuitry 222, Bluetooth processing circuitry 221, WLAN processing circuitry 229, mesh network processing circuitry 236).

As illustrated in FIG. 5, at block 502, the apparatus receives, from the end device 210 of FIG. 2, a data poll message that includes timing information indicating an available time window during which the end device 210 expects a data transmission associated with a first wireless communication protocol following a wakeup event at the end device 210. In one or more other implementations, the data poll message may indicate a length of an incoming frame configured to fit inside the available time window, which may correspond to the size of a maximum packet length. In one or more other implementations, the data poll message indicates the number of retransmissions possible.

At block 504, the apparatus provides for transmission, to the end device 210, an acknowledgement message indicating whether data is available for transmission to the end device 210. At block 506, the apparatus schedules a data transmission associated with the first wireless communication protocol based at least in part on the timing information. At block 508, the apparatus provides for transmission, to the end device 210, the data transmission associated with the first wireless communication protocol.

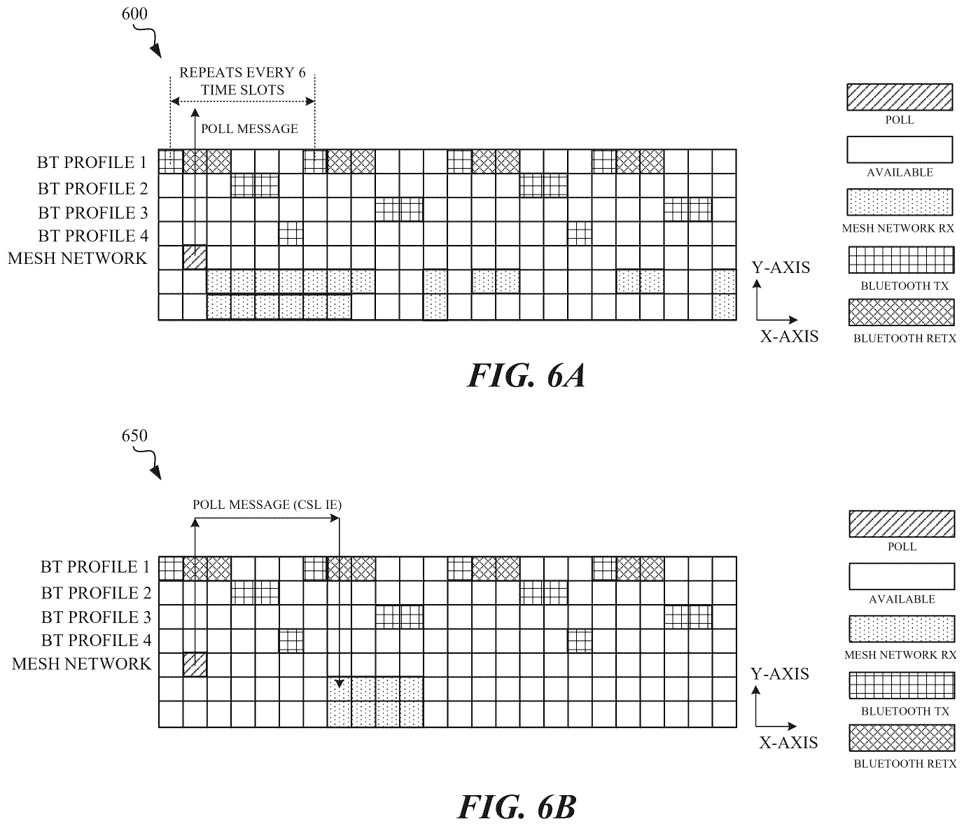

FIG. 6A conceptually illustrates an example of a resource grid 600 with an example data poll procedure in accordance with one or more implementations. In one or more implementations, the x-axis of the resource grid 600 represents time divided into time slots, each about 1.25 milliseconds long, while the y-axis of the resource grid 600 represents different Bluetooth profiles during various activities. Each time slot may be used by a Bluetooth radio to send one frame. Bluetooth transmissions may be interleaved to avoid overlapping. Each Bluetooth profile may transmit data in specific slots, with retransmissions occurring in subsequent slots if needed. This arrangement of time slots facilitates efficient use of the Bluetooth radio.

For a phone, the resource grid 600 shows a transmission pattern that includes a first time slot as a primary Bluetooth time slot and the next two being Bluetooth retransmission slots. For example, during a voice call over Long-Term Evolution (LTE) on a phone while listening to Bluetooth audio through one or more wearable listening devices (e.g., represented as BT profile 1), the BT profile 1 is active. In this case, the Bluetooth connection may use a Bluetooth transmission slot to transmit data from the phone to the wearable devices. If needed, the phone may retransmit the audio data in subsequent slots using the Bluetooth retransmission slots.

As illustrated in FIG. 6A, this transmission pattern may repeat approximately every 6 time slots. When considering a desktop computer with human interface devices (HIDs) such as a mouse, trackpad, and keyboard, additional times slots may be involved. For example, a mouse (represented as BT profile 2) typically uses two slots, repeating approximately every 12 time slots, while the trackpad (represented as BT profile 3) and keyboard (represented as BT profile 4) also use designated time slots.

As illustrated in FIG. 6A, the resource grid 600 involves the coexistence between a mesh network wireless communication protocol and Bluetooth, both of which may operate on the same radio frequency (e.g., 2.4 GHz). Their coexistence may necessitate non-overlapping usage of resources to avoid interference between the two wireless communication protocols. When a transmitter associated with the mesh network protocol initiates a data poll message (or data request message), such as when a SED needs to unlock a door, it requests incoming data. According to the IEEE 802.15.4 specification, the SED may need to wait for up to 100 milliseconds to receive the data. The resource grid 600 illustrates time intervals during which the device is waiting for incoming data (denoted as mesh network rx). Concurrently, other Bluetooth activities involving accessories such as wearable listening devices (e.g., BT profile 1), a mouse (e.g., BT profile 2), a keyboard (e.g., BT profile 4), and a trackpad (e.g., BT profile 3) may need to be coordinated to avoid conflicts. Each accessory has specific slots assigned for communication to facilitate seamless operation within the shared 2.4 GHz frequency band.

In Bluetooth, time slot allocation varies depending on the specific use case, such as audio transmission or low-latency human interface devices. These resource allocations may accommodate different types of data transmission. However, a challenge arises when multiple Bluetooth activities are active simultaneously, particularly concerning the integration of mesh network traffic with the Bluetooth traffic. When all Bluetooth activities are active, the available time slots in the resource grid 600 for the mesh network radio to receive data may be limited to retransmission slots or empty time slots. The reliability of the mesh network radio reception in the presence of Bluetooth coexistence becomes a significant challenge. The probability of receiving a frame by the mesh network radio may be dependent on whether the frame transmission falls within a free time slot. If the frame transmission aligns with a Bluetooth slot, reception may not occur. However, if the frame transmission aligns with an empty time slot, reception may be possible. The probability of reception may be calculated as the number of free time slots divided by the total number of time slots in the resource grid 600.

FIG. 6B conceptually illustrates an example of a resource grid 650 with an example enhanced data poll procedure in accordance with one or more implementations. As illustrated in FIG. 6B, the transmission repetition interval may vary depending on the device's bandwidth requirements. For instance, audio transmissions necessitate a higher repetition rate due to their higher bandwidth, resulting in shorter time slots and a repetition interval of 6 time slots. In contrast, human interface devices with lower bandwidth requirements, such as a mouse (e.g., BT profile 2) and a keyboard (e.g., BT profile 4), have longer repetition intervals. The mouse and trackpad (e.g., BT profile 3) repeat every 12 time slots, while the keyboard repeats every 12 time slots but may only allocate one time slot due to its lower utility.

As illustrated in FIG. 6A, the data poll procedure required the SED (or child device) to wait for data for a substantial length of time immediately following transmission of the data poll message (or data request message), causing burdensome power consumption by the SED. In contrast, as illustrated in FIG. 6B, the SED follows an enhanced data polling procedure, in which the child device sends a data poll message to the parent device indicating a preferred time slot for data reception. This time slot may be chosen to avoid interference with existing Bluetooth traffic. By coordinating with the parent device, the SED can facilitate that data can be received without disrupting ongoing Bluetooth transmissions. This enhanced data poll procedure helps optimize data reception in coexistence-constrained environments. Implementing the enhanced data poll approach offers advantages over a standard data poll procedure. Firstly, it ensures that ongoing traffic of other wireless communication protocols remains uninterrupted. Secondly, it reduces the duration for which the device's receiver needs to remain active, reducing power consumption.

In one or more implementations, a child device communicates its preferred reception time to a parent device through a message called a poll message. The poll message can include a CSL IE that facilitates synchronized communication between devices by allowing them to sample the communication medium for data transmissions at coordinated intervals. CSL IE may be a protocol in mesh networks that informs the parent device of the child's listening schedule. For example, the CSL IE may include information on the timing and duration of the coordinated listening intervals. Upon receiving this information, the parent device schedules its transmission accordingly. The parent device can transmit the data during the specified time window indicated by the child device. Subsequently, when the child device polls for data, it activates its receiver at the predetermined time, eliminating the need to wait for reception continuously. If either the parent device fails to transmit data or the receiving child device fails to receive the data at a designated time slot, additional attempts can be made using subsequent time slots corresponding to the duration of the coordinated listening intervals (e.g., indicated by the period value in the timing information).

FIG. 7 conceptually illustrates another example of a resource grid 700 with another example enhanced data poll procedure in accordance with one or more implementations. In one or more implementations, one data poll message can indicate a sequence of time slots (or referred to as a train of time slots) available for coexistence communication between a child device and a parent device. These time slots may be defined intervals within which devices can communicate, facilitating coordinated and efficient use of the communication medium. The indication of these time slots through a single data poll message allows devices to schedule their transmissions, optimizing the coexistence of multiple devices within a mesh network (e.g., mesh network 150 of FIG. 1).

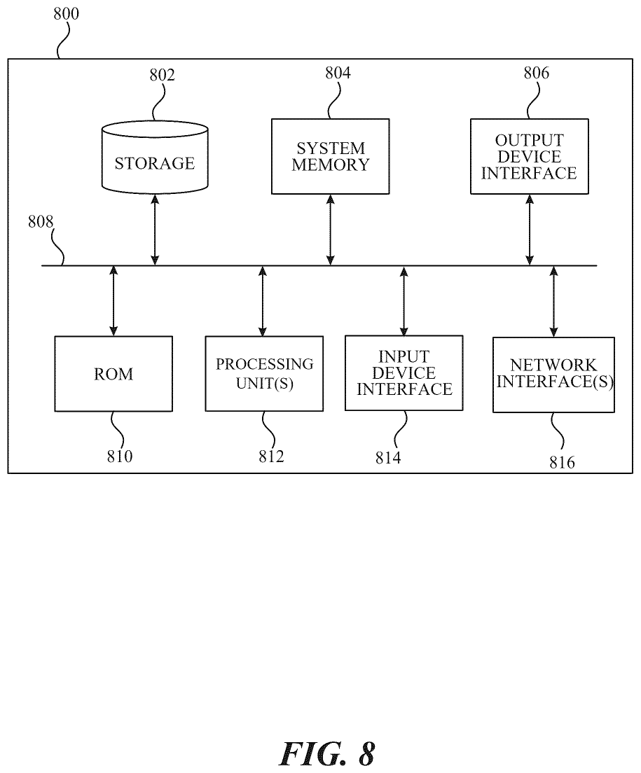

FIG. 8 illustrates an electronic system 800 with which one or more implementations of the subject technology may be implemented. The electronic system 800 can be, and/or can be a part of, any one of the electronic devices 110-112 and/or the server 120 shown in FIG. 1; the end device 210 and/or the router 220 shown in FIG. 2; the child device 310 and/or the parent device 320 shown in FIG. 3. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a flash drive, and its corresponding solid-state drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input device interface 814 and output device interface 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 110 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
processing circuitry configured to perform operations comprising:
initiating, based at least in part on a wakeup event, a data poll message comprising timing information indicating a time window during which the apparatus expects a data transmission associated with a first wireless communication protocol;
providing the data poll message for transmission to a parent device configured for managing communication with the apparatus;
receiving, from the parent device, an acknowledgement message indicating whether data is available for transmission to the apparatus; and
monitoring for reception of a data transmission associated with the first wireless communication protocol from the parent device during at least a portion of the time window based on the acknowledgment message indicating that data is available for transmission to the apparatus.

2. The apparatus of claim 1, wherein the operations further comprise receiving, from the parent device, the data transmission associated with the first wireless communication protocol during the at least a portion of the time window.

3. The apparatus of claim 1, wherein the data poll message comprises a coordinated sampled listening (CSL) information element, and wherein the timing information is included in at least a portion of the CSL information element.

4. The apparatus of claim 1, wherein the timing information comprises an offset value and a period value, and wherein the time window is defined by the offset value and the period value, wherein the offset value indicates an occurrence of a first time slot of one or more consecutive time slots following conclusion of an operation by a transmitter associated with a second wireless communication protocol different from the first wireless communication protocol, and wherein the period value indicates a time between each subsequent occurrence of the first time slot.

5. The apparatus of claim 1, wherein the operations further comprise transitioning into a sleep state based on the acknowledgment message indicating that data is not available for transmission to the apparatus.

6. The apparatus of claim 1, wherein the operations further comprise:
determining a coexistence activity between a transmitter associated with the first wireless communication protocol and a transmitter associated with a second wireless communication protocol different from the first wireless communication protocol; and
adjusting one or more of a periodicity or width of the time window based on the coexistence activity.

7. The apparatus of claim 6, wherein determining the coexistence activity comprises determining one or more available time slots following conclusion of an operation by the transmitter associated with the second wireless communication protocol, and wherein the time window comprises the one or more available time slots.

8. The apparatus of claim 7, wherein the data transmission is configured to align with at least one of the one or more available time slots in the time window.

9. The apparatus of claim 8, wherein the operations further comprise activating a receiver associated with the first wireless communication protocol during the at least one of the one or more available time slots in the time window.

10. The apparatus of claim 6, wherein the first wireless communication protocol comprises a mesh network communication protocol and the second wireless communication protocol comprises Bluetooth or Wi-Fi.

11. The apparatus of claim 1, wherein the wakeup event corresponds to detection of a wakeup state by the apparatus.

12. The apparatus of claim 1, wherein the apparatus is in a sleep state prior to the wakeup event.

13. A method comprising:
initiating, by a first device, based at least in part on a wakeup event, a data poll message comprising timing information indicating a time window during which the first device expects a data transmission associated with a first wireless communication protocol;
providing the data poll message for transmission to a second device configured for managing communication with the first device;
receiving, from the second device, an acknowledgement message indicating whether data is available for transmission to the first device; and
monitoring for reception of a data transmission associated with the first wireless communication protocol from the second device during at least a portion of the time window based on the acknowledgment message indicating that data is available for transmission to the first device.

14. The method of claim 13, further comprising receiving the data transmission associated with the first wireless communication protocol during the at least a portion of the time window.

15. The method of claim 13, further comprising transitioning into a sleep state based on the acknowledgment message indicating that data is not available for transmission to the first device.

16. The method of claim 13, further comprising:
determining a coexistence activity between a transmitter associated with the first wireless communication protocol of the first device and a transmitter associated with a second wireless communication protocol different from the first wireless communication protocol of the first device; and
adjusting one or more of a periodicity or width of the time window based on the coexistence activity.

17. The method of claim 16, wherein determining the coexistence activity comprises determining one or more available time slots following conclusion of an operation by the transmitter associated with the second wireless communication protocol, and wherein the time window comprises the one or more available time slots, and wherein the data transmission is configured to align with at least one of the one or more available time slots in the time window.

18. The method of claim 13, wherein the data poll message comprises a coordinated sampled listening (CSL) information element, and wherein the timing information is included in at least a portion of the CSL information element.

19. The method of claim 13, wherein the timing information comprises an offset value and a period value, and wherein the time window is defined by the offset value and the period value, wherein the offset value indicates an occurrence of a first time slot of one or more consecutive time slots following conclusion of an operation by a transmitter associated with a second wireless communication protocol different from the first wireless communication protocol, and wherein the period value indicates a time between each subsequent occurrence of the first time slot.

20. An apparatus comprising:
processing circuitry configured to perform operations comprising:
receiving, from an end device, a data poll message comprising timing information indicating a time window during which the end device expects a data transmission associated with a first wireless communication protocol following a wakeup event at the end device;
providing for transmission, to the end device, an acknowledgement message indicating whether data is available for transmission to the end device;
scheduling a data transmission associated with the first wireless communication protocol based at least in part on the timing information; and
providing for transmission, to the end device, the data transmission associated with the first wireless communication protocol.
